(19) United States
(12) Patent Application Publication
(10) Pub. No.: US 2026/0246210 A1
(43) Pub. Date: Aug. 20, 2026

(54) OUTPUT SOCKET AND OUTDOOR POWER SUPPLY

(71) Applicant: TWS TECHNOLOGY (GUANGZHOU) LIMITED, Guangzhou (CN)

(72) Inventors: Qingyun Chen, Guangzhou (CN); Guang Ouyang, Guangzhou (CN)

(21) Appl. No.: 19/641,590

(22) Filed: Apr. 8, 2026

Related U.S. Application Data
(63) Continuation-in-part of application No. PCT/CN2024/134422, filed on Nov. 26, 2024.

(30) Foreign Application Priority Data
Apr. 15, 2024 (CN) 202410449482.2

(51) Int. Cl. H01R 13/66; H01R 13/52; H01R 13/703

(52) U.S. Cl. CPC H01R 13/6683; H01R 13/5202; H01R 13/5227; H01R 13/7036

(57) ABSTRACT

An output socket includes a socket body, a live terminal contact, a neutral terminal contact, and an earth terminal contact. The socket body is provided therein with a live terminal cavity, a neutral terminal cavity, and an earth terminal cavity. The neutral terminal contact includes a first elastic contact and a second elastic contact, which are not electrically connected and clamp a neutral pin of a load plug through cooperation. The first elastic contact connects to a neutral line, and the second elastic contact connects to a detection signal line. When no load plug is inserted, the first and second elastic contacts are disconnected, causing the output socket to be in standby, and an outdoor power supply does not provide an AC output, so the neutral and live terminal contacts of the output socket are disconnected from the neutral line and a live line of the outdoor power supply.

### CROSS REFERENCE TO RELATED APPLICATIONS

The present application is a Continuation-in-part Application of PCT Application No. PCT/CN2024/134422 filed on November 26, 2024, which claims the benefit of Chinese Patent Application No. 202410449482.2 filed on April 15, 2024. All the above are hereby incorporated by reference in their entirety.

### TECHNICAL FIELD

The present disclosure relates to a technical field of electrical equipment, and in particular, to an output socket and an outdoor power supply.

### BACKGROUND

Sockets are primarily used to supply power to electrical appliances. Due to a variety of usage environments for the sockets, higher requirements are imposed on the sockets used in environments with high moisture, such as outdoors or bathrooms. Such sockets typically need to possess waterproof capabilities to ensure user safety. Currently, conventional alternating-current (AC) socket outlets for outdoor use remain energized even in a standby mode. If the socket becomes submerged in or splashed with water, water may remain inside afterward. If a user then touches a surface of the socket, there is a risk of electric shock, presenting a safety hazard.

### SUMMARY

An objective of the present disclosure is to provide an output socket to solve a technical problem in the prior art that a conventional alternating-current (AC) socket outlet remains energized even in a standby mode, posing a risk of electric shock and presenting a safety hazard after the socket has been submerged in or splashed with water.

To achieve the above objective, a first aspect of the present disclosure provides an output socket, including: a socket body, a live terminal contact, a neutral terminal contact, and an earth terminal contact; where the socket body is provided therein with a live terminal cavity, a neutral terminal cavity, and an earth terminal cavity; the live terminal contact is disposed in the live terminal cavity, the neutral terminal contact is disposed in the neutral terminal cavity, and the earth terminal contact is disposed in the earth terminal cavity, the neutral terminal contact includes a first elastic contact and a second elastic contact which are not electrically connected with each other, the first elastic contact is configured to connect to a neutral line, the second elastic contact is configured to connect to a detection signal line, and the first elastic contact and the second elastic contact are configured to clamp a neutral pin of a load plug through cooperation.

Preferably, the live terminal cavity, the neutral terminal cavity, and the earth terminal cavity are not in communication with one another; the socket body is provided with a face panel; the face panel is provided with a live terminal insertion port, a neutral terminal insertion port, and an earth terminal insertion port; the live terminal insertion port is in communication with the live terminal cavity, the neutral terminal insertion port is in communication with the neutral terminal cavity, and the earth terminal insertion port is in communication with the earth terminal cavity.

Preferably, the socket body is further provided with a first drainage channel, a second drainage channel, and a third drainage channel; the first drainage channel is in communication with an end of the live terminal cavity facing the live terminal insertion port; the second drainage channel is in communication with an end of the neutral terminal cavity facing the neutral terminal insertion port; and the third drainage channel is in communication with an end of the earth terminal cavity facing the earth terminal insertion port.

Preferably, the socket body is provided with a partition cavity between the live terminal cavity and the neutral terminal cavity; the third drainage channel is located within the partition cavity; an outlet of the first drainage channel, an outlet of the second drainage channel, and an outlet of the third drainage channel are all located at a bottom of the face panel.

Preferably, a first partition piece is provided between the outlet of the first drainage channel and the outlet of the third drainage channel; and a second partition piece is provided between the outlet of the second drainage channel and the outlet of the third drainage channel.

Preferably, the face panel is further provided with a first isolation cavity and a second isolation cavity; the first isolation cavity is disposed between the live terminal insertion port and the live terminal contact; and the second isolation cavity is disposed between the neutral terminal insertion port and the neutral terminal contact.

Preferably, the bottom of the face panel is further provided with a first drainage port and a second drainage port; the first drainage port is in communication with the first isolation cavity, and the second drainage port is in communication with the second isolation cavity.

Preferably, the face panel is provided with a water isolation groove at a location between the live terminal insertion port and the neutral terminal insertion port; an outlet of the water isolation groove extends to the bottom of the face panel.

Preferably, the output socket further includes: a waterproof gasket and a rear pressure plate; the waterproof gasket is located on a side of the rear pressure plate facing the socket body; the waterproof gasket and the rear pressure plate seal a rear opening of the live terminal cavity, a rear opening of the neutral terminal cavity, and a rear opening of the earth terminal cavity; and a side of the rear pressure plate facing away from the waterproof gasket is provided with a waterproof adhesive layer.

A second aspect of the present disclosure provides an outdoor power supply, including the output socket as described above and a control component, where the control component is provided with the detection signal line, and the detection signal line is connected to the second elastic contact.

Compared with the prior art, the output socket and the outdoor power supply provided in the present disclosure have beneficial effects as follows: the neutral terminal contact includes the first elastic contact and the second elastic contact. The first elastic contact is connected to the neutral line, and the second elastic contact is connected to the detection signal line. When no load plug is inserted, the first elastic contact and the second elastic contact are disconnected. The control component then determines that no load is inserted, and the output socket is in a standby mode. The outdoor power supply does not provide an AC output to the output socket. Consequently, at this time, both the neutral terminal contact and the live terminal contact of the output socket are disconnected from the neutral line and a live line of the outdoor power supply. If a user touches the output socket in the standby mode, there is no risk of electric shock, eliminating safety hazards. Therefore, even if the output socket in the standby mode becomes submerged in or splashed with water, it will not be electrically connected to the neutral line and the live line of the outdoor power supply. Thus, if the user touches a surface of the socket under such conditions, no electric shock will occur, reducing the risk of electric shock after the socket is submerged in or splashed with water and eliminating safety hazards.

Additional aspects and advantages of the present disclosure will be partly set forth in the following description, and will partly become apparent from the following description, or may be learned through practice of the present disclosure.

### BRIEF DESCRIPTION OF THE DRAWINGS

FIG. 1 is a schematic structural diagram of an output socket according to an embodiment of the present disclosure;

FIG. 2 is an exploded structural diagram of the output socket according to an embodiment of the present disclosure;

FIG. 3 is a structural diagram showing a rear of a socket body according to an embodiment of the present disclosure;

FIG. 4 is a schematic structural diagram showing an arrangement of a first drainage channel, a second drainage channel, and a third drainage channel according to an embodiment of the present disclosure;

FIG. 5 is a cross-sectional view of the output socket according to an embodiment of the present disclosure;

FIG. 6 is a cross-sectional view of an outdoor power supply according to an embodiment of the present disclosure.

In the figures: 100: socket body; 110: live terminal cavity; 120: neutral terminal cavity; 130: earth terminal cavity; 140: face panel; 141: live terminal insertion port; 142: neutral terminal insertion port; 143: earth terminal insertion port; 144: first partition piece; 145: second partition piece; 146: first isolation cavity; 147: second isolation cavity; 148: first drainage port; 149: second drainage port; 150: first drainage channel; 160: second drainage channel; 170: third drainage channel; 180: partition cavity; 190: water isolation groove; 200: live terminal contact; 300: neutral terminal contact; 310: first elastic contact; 320: second elastic contact; 400: earth terminal contact; 500: waterproof gasket; 600: rear pressure plate; 610: waterproof adhesive layer; 700: control component; 800: housing; 810: housing waterproof gasket; 820: waterproof adhesive sealing layer; 900: detection signal line; and 910: neutral line.

### DETAILED DESCRIPTION

Detailed descriptions of embodiments of the present disclosure are provided below. Examples of the embodiments are illustrated in the accompanying drawings, in which the same or similar reference numerals refer to the same or similar elements or elements having the same or similar functions throughout. The embodiments described below with reference to the accompanying drawings are exemplary and are only used to explain the present disclosure, and should not be construed as limiting the present disclosure.

In the description of the present disclosure, it should be understood that terms indicating orientations or positional relationships, such as "upper", "lower", "front", "rear", "left", "right", etc., are based on the orientations or positional relationships shown in the accompanying drawings. They are used only for convenience in describing the present disclosure and for simplifying the description, and are not intended to indicate or imply that the device or element referred to must have a specific orientation or be constructed and operated in a specific orientation. Thus, they should not be construed as limiting the present disclosure.

In the description of the present disclosure, the term "some" means one or more, and “a plurality of” or "multiple" means two or more. Terms such as "greater than", "less than", and "exceeding" are understood to not include the present number, while terms such as "above", "below", and "within" are understood to include the present number. If terms such as "first" and "second" are used, they are used only for the purpose of distinguishing technical features and should not be construed as indicating or implying relative importance, or implicitly indicating the quantity of the indicated technical features, or the sequence of the indicated technical features.

In the description of the present disclosure, unless explicitly limited otherwise, terms such as "provided", "installed", and "connected" should be understood in a broad sense. Those skilled in the art can reasonably determine the specific meanings of these terms in the present disclosure in conjunction with the specific content of the technical solution.

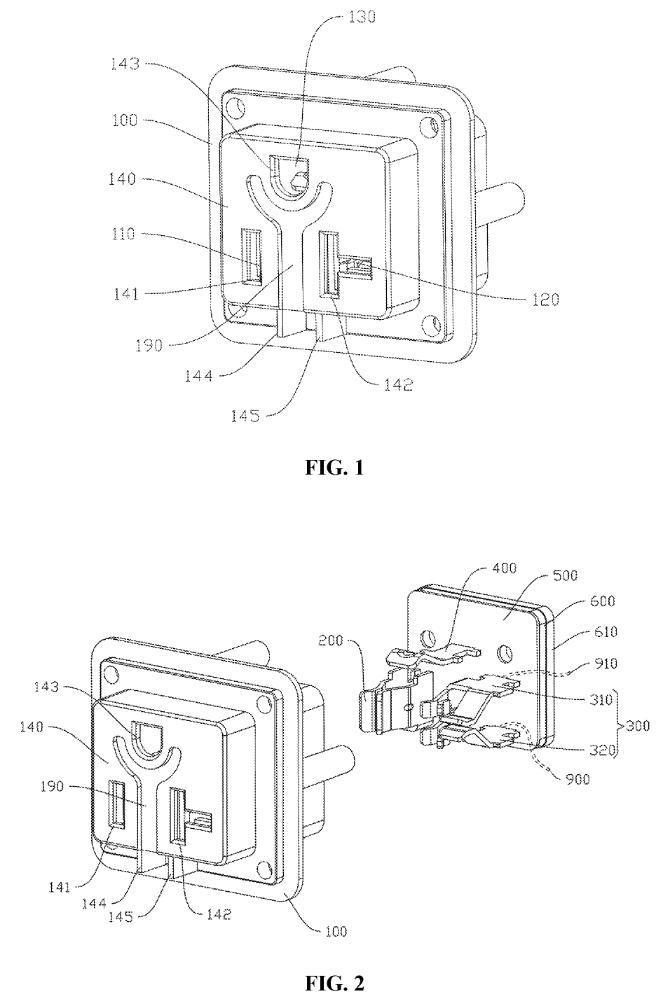

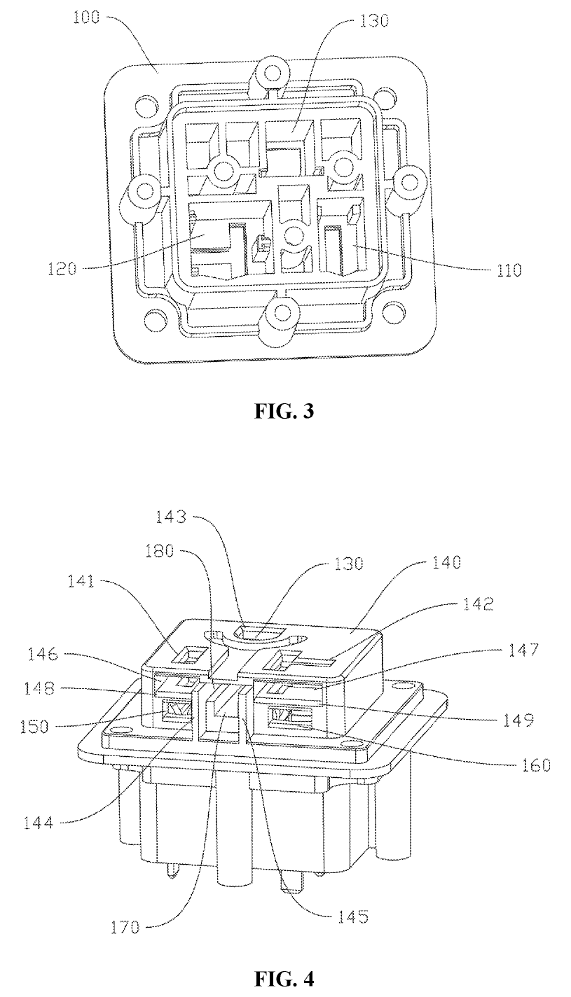

Referring to FIGS. 1 to 6, an output socket provided in embodiments of the present disclosure will now be described.

Referring to FIGS. 1 to 3, the output socket of an embodiment of the present disclosure includes: a socket body 100, a live terminal contact 200, a neutral terminal contact 300, and an earth terminal contact 400. The socket body 100 is provided therein with a live terminal cavity 110, a neutral terminal cavity 120, and an earth terminal cavity 130. The live terminal contact 200 is disposed in the live terminal cavity 110, the neutral terminal contact 300 is disposed in the neutral terminal cavity 120, and the earth terminal contact 400 is disposed in the earth terminal cavity 130. The neutral terminal contact 300 includes a first elastic contact 310 and a second elastic contact 320 which are not electrically connected with each other. The first elastic contact 310 is configured to connect to a neutral line 910. The second elastic contact 320 is configured to connect to a detection signal line 900. The first elastic contact 310 and the second elastic contact 320 are configured to clamp a neutral pin of a load plug through cooperation.

Referring to FIGS. 1 to 3, the live terminal contact 200, the earth terminal contact 400, and the neutral terminal contact 300 all consist of metal elastic contacts. The live terminal contact 200 is configured to connect to a live line, and the earth terminal contact 400 is configured to connect to an earth line for grounding. The live terminal contact 200, the earth terminal contact 400, and the neutral terminal contact 300 are respectively disposed in the live terminal cavity 110, the earth terminal cavity 130, and the neutral terminal cavity 120 to increase a creepage distance between the metal elastic contacts of the live terminal contact 200, the earth terminal contact 400, and the neutral terminal contact 300. The live terminal contact 200, the earth terminal contact 400, and the neutral terminal contact 300 are respectively configured to contact a live pin, an earth pin, and the neutral pin of the load plug. When the load plug is inserted into the output socket of the embodiment, the live pin of the load plug contacts the live terminal contact 200, the neutral pin of the load plug contacts the first elastic contact 310 and the second elastic contact 320, and the earth pin of the load plug contacts the earth terminal contact 400. At this point, the first elastic contact 310 becomes electrically connected with the second elastic contact 320 through the neutral pin of the load plug. The second elastic contact 320 is connected to the detection signal line 900, and the detection signal line 900 is connected to a control component 700 of an outdoor power supply. When the second elastic contact 320 and the first elastic contact 310 become electrically connected through the neutral pin of the load plug, the control component 700 may detect a potential change through the detection signal line 900 and thus determine that a load is inserted into the output socket. The outdoor power supply then provides an alternating-current (AC) output to the output socket. When no load is inserted into the output socket, the first elastic contact 310 and the second elastic contact 320 are disconnected. The control component 700 then determines that no load is inserted into the output socket, and the output socket is in a standby mode. The outdoor power supply does not provide the AC output to the output socket. Consequently, at this time, both the neutral terminal contact 300 and the live terminal contact 200 of the output socket are disconnected from the neutral line and the live line of the outdoor power supply. If a user touches the output socket in the standby mode, there is no risk of electric shock, eliminating safety hazards.

Therefore, even if the output socket in the standby mode becomes submerged in or splashed with water, it will not be electrically connected to the neutral line and the live line of the outdoor power supply. Thus, if a user touches a surface of the output socket at this time, no electric shock will occur, reducing the risk of electric shock after the socket is submerged in or splashed with water and eliminating safety hazards.

Referring to FIGS. 1 to 3, in some embodiments of the present disclosure, the live terminal cavity 110, the neutral terminal cavity 120, and the earth terminal cavity 130 are not in communication with one another. The socket body 100 is provided with a face panel 140. The face panel 140 is provided with a live terminal insertion port 141, a neutral terminal insertion port 142, and an earth terminal insertion port 143. The live terminal insertion port 141 is in communication with the live terminal cavity 110, the neutral terminal insertion port 142 is in communication with the neutral terminal cavity 120, and the earth terminal insertion port 143 is in communication with the earth terminal cavity 130. That is, the live terminal cavity 110, the neutral terminal cavity 120, and the earth terminal cavity 130 of the socket body 100 are not in communication with one another, which may effectively increase the creepage distance between the live terminal contact 200, neutral terminal contact 300, and earth terminal contact 400, preventing arcing between the live terminal contact 200, neutral terminal contact 300, and earth terminal contact 400 and avoiding burning of a plastic surface due to an insufficient creepage distance between the metal elastic contacts of the live terminal contact 200, the earth terminal contact 400, and the neutral terminal contact 300. Moreover, after the output socket is taken out of fresh water or salt water and connected to a 120V supply, no short circuit will occur between the live terminal contact 200, the neutral terminal contact 300, and the earth terminal contact 400.

Referring to FIGS. 1 to 4, in some embodiments of the present disclosure, the socket body 100 is further provided with a first drainage channel 150, a second drainage channel 160, and a third drainage channel 170. The first drainage channel 150 is in communication with an end of the live terminal cavity 110 facing the live terminal insertion port 141. Thus, water entering the live terminal cavity 110 from the live terminal insertion port 141 may be drained to an outside of the socket through the first drainage channel 150, preventing the water from remaining in the live terminal cavity 110. Moreover, after the socket is submerged, water inside the live terminal cavity 110 may be quickly drained through the first drainage channel 150, reducing water residue. Similarly, the second drainage channel 160 is in communication with an end of the neutral terminal cavity 120 facing the neutral terminal insertion port 142. Thus, water entering the neutral terminal cavity 120 from the neutral terminal insertion port 142 may be drained to the outside of the socket through the second drainage channel 160, preventing the water from remaining in the neutral terminal cavity 120. Moreover, after the socket is submerged, water inside the neutral terminal cavity 120 may be quickly drained through the second drainage channel 160, reducing water residue. Similarly, the third drainage channel 170 is in communication with an end of the earth terminal cavity 130 facing the earth terminal insertion port 143. Thus, water entering the earth terminal cavity 130 from the earth terminal insertion port 143 may be drained to the outside of the socket through the third drainage channel 170, preventing the water from remaining in the earth terminal cavity 130. Moreover, after the socket is submerged, water inside the earth terminal cavity 130 may be quickly drained through the third drainage channel 170, reducing water residue.

Referring to FIGS. 1 to 4, in some embodiments of the present disclosure, the socket body 100 is provided with a partition cavity 180 between the live terminal cavity 110 and the neutral terminal cavity 120. The third drainage channel 170 is located within the partition cavity 180. The partition cavity 180 separates the live terminal cavity 110 and the neutral terminal cavity 120, with the third drainage channel 170 being disposed within the partition cavity 180, thereby effectively utilizing space and achieving a more compact structural layout. When the face panel 140 is oriented vertically (refer to FIG. 1), an outlet of the first drainage channel 150, an outlet of the second drainage channel 160, and an outlet of the third drainage channel 170 are all located at a bottom of the face panel 140. An inlet of the first drainage channel 150 is located at a lower side of the live terminal cavity 110, an inlet of the second drainage channel 160 is located at a lower side of the neutral terminal cavity 120, and an inlet of the third drainage channel 170 is located at a lower side of the earth terminal cavity 130. When the output socket is in use, the face panel 140 is oriented vertically, with the earth terminal insertion port 143 located above an area between the neutral terminal insertion port 142 and the live terminal insertion port 141, and the third drainage channel 170 is disposed within the partition cavity 180 between the live terminal cavity 110 and the neutral terminal cavity 120, which allows accumulated water or externally entering water to more effectively flow into the third drainage channel 170 through an upper inlet thereof and drain downward, thereby facilitating drainage. Similarly, water entering the neutral terminal cavity 120 and the live terminal cavity 110 may also more effectively enter the first drainage channel 150 through the inlet of the first drainage channel 150 and the second drainage channel 160 through the inlet of the second drainage channel 160, respectively, thereby facilitating downward drainage of accumulated water in the neutral terminal cavity 120 and the live terminal cavity 110.

Referring to FIGS. 1 to 4, in some embodiments of the present disclosure, a first partition piece 144 is provided between the outlet of the first drainage channel 150 and the outlet of the third drainage channel 170. A second partition piece 145 is provided between the outlet of the second drainage channel 160 and the outlet of the third drainage channel 170. Since the outlet of the first drainage channel 150, the outlet of the third drainage channel 170, and the outlet of the second drainage channel 160 are all located at the bottom of the face panel 140, using the first partition piece 144 and the second partition piece 145 may increase the creepage distance between the live terminal contact 200, the neutral terminal contact 300, and the earth terminal contact 400, reduce arcing between the metal elastic contacts of the live terminal contact 200, the earth terminal contact 400, and the neutral terminal contact 300, and prevent burning of the surface of the socket due to an insufficient creepage distance.

Referring to FIGS. 1 to 4, in some embodiments of the present disclosure, the face panel 140 is further provided with a first isolation cavity 146 and a second isolation cavity 147. The first isolation cavity 146 is disposed between the live terminal insertion port 141 and the live terminal contact 200. The second isolation cavity 147 is disposed between the neutral terminal insertion port 142 and the neutral terminal contact 300. The first isolation cavity 146 serves as an air isolation zone, isolating the live terminal contact 200 from a surface of the face panel 140 of the socket, and further reducing the risk of electric shock to the user. Similarly, the second isolation cavity 147 serves as an air isolation zone, isolating the neutral terminal contact 300 from the surface of the face panel 140 of the socket, and further reducing the risk of electric shock to the user.

Referring to FIGS. 1 to 4, in some embodiments of the present disclosure, the bottom of the face panel 140 is further provided with a first drainage port 148 and a second drainage port 149. The first drainage port 148 is in communication with the first isolation cavity 146, and the second drainage port 149 is in communication with the second isolation cavity 147. Thus, water entering the first isolation cavity 146 may drain downward through the first drainage port 148, and water entering the second isolation cavity 147 may drain downward through the second drainage port 149, which prevents water accumulation within the first isolation cavity 146 and the second isolation cavity 147, thereby ensuring that the first isolation cavity 146 and the second isolation cavity 147 function as air isolation zones.

Referring to FIGS. 1 to 4, in some embodiments of the present disclosure, the face panel 140 is provided with a water isolation groove 190 at a location between the live terminal insertion port 141 and the neutral terminal insertion port 142, and an outlet of the water isolation groove 190 extends to the bottom of the face panel 140, which allows water on the face panel 140 to drain downward along the water isolation groove 190 when there is water on the face panel 140 of the socket, reducing water accumulation on the face panel 140 and making it difficult to form a short circuit or conduction between the neutral line and the live line. Furthermore, the provision of the water isolation groove 190 also increases the creepage distance between the live terminal contact 200 and the neutral terminal contact 300, reducing arcing between the metal elastic contacts.

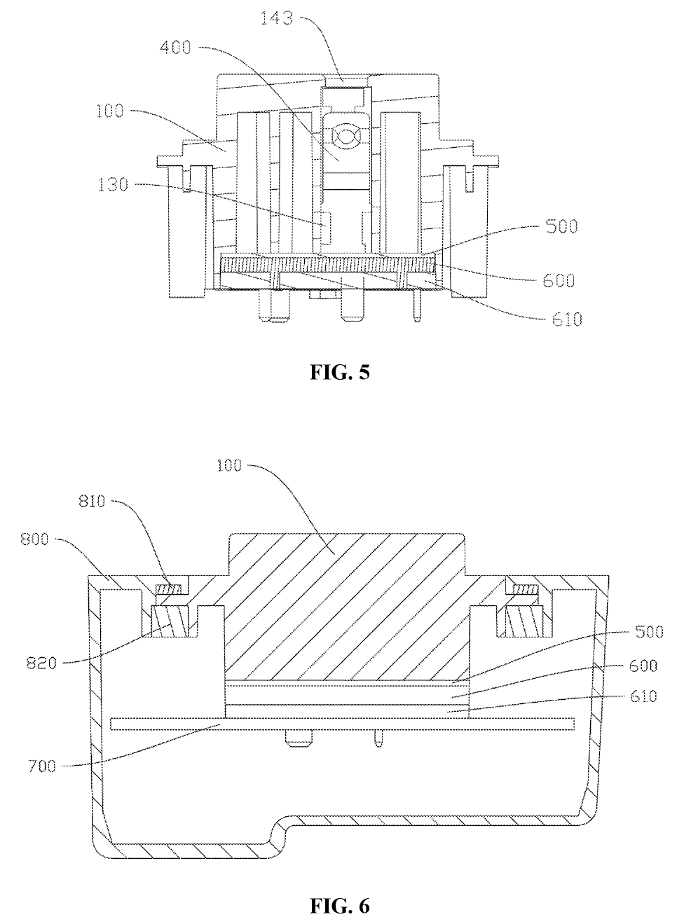

Referring to FIGS. 2 and 5, in some embodiments of the present disclosure, the output socket further includes: a waterproof gasket 500 and a rear pressure plate 600. The waterproof gasket 500 is located on a side of the rear pressure plate 600 facing the socket body 100. The waterproof gasket 500 and the rear pressure plate 600 seal a rear opening of the live terminal cavity 110, a rear opening of the neutral terminal cavity 120, and a rear opening of the earth terminal cavity 130. A side of the rear pressure plate 600 facing away from the waterproof gasket 500 is provided with a waterproof adhesive layer 610. Gaps between the rear pressure plate 600 and the socket body 100 are filled with waterproof adhesive, so as to seal the gaps between the rear pressure plate 600 and the socket body 100. Thus, in cooperation with the waterproof gasket 500, the rear pressure plate 600 seals the rear opening of the live terminal cavity 110, the rear opening of the neutral terminal cavity 120, and the rear opening of the earth terminal cavity 130, preventing water from entering an interior of the outdoor power supply through the live terminal cavity 110, the neutral terminal cavity 120, and the earth terminal cavity 130, thereby providing a waterproof function. Moreover, the waterproof adhesive layer 610 may also seal gaps between the rear pressure plate 600 and the elastic contacts of the live terminal contact 200, the neutral terminal contact 300, and the earth terminal contact 400, respectively, reducing a risk of water leakage and improving a waterproof rating.

Referring to FIG. 6, an embodiment also provides the outdoor power supply, including the output socket as described above, the control component 700, and a housing 800. The control component 700 is provided with the detection signal line 900, and the detection signal line 900 is connected to the second elastic contact 320. The housing 800 is provided with an installation cavity and a socket installation port. The output socket is fixed at the socket installation port with the face panel 140 thereof facing outward. A connection between the output socket and the housing 800 is sealed using a housing waterproof gasket 810 and a waterproof adhesive sealing layer 820. The control component 700 may be a printed circuit board (PCB) configured to process information and control disconnection of the neutral line and/or the live line, thereby controlling whether the output socket provides AC output.

In summary, the output socket and the outdoor power supply of the embodiments at least have the following beneficial effects:

First, the neutral terminal contact 300 includes the first elastic contact 310 and the second elastic contact 320. The first elastic contact 310 is connected to the neutral line, and the second elastic contact 320 is connected to the detection signal line 900. When no load plug is inserted, the first elastic contact 310 and the second elastic contact 320 are disconnected. The control component 700 then determines that no load is inserted, the output socket is in a standby mode, and the outdoor power supply does not provide the AC output to the output socket. Thus, at this time, both the neutral terminal contact 300 and the live terminal contact 200 of the output socket are disconnected from the neutral line and the live line of the outdoor power supply. If a user touches the output socket in the standby mode, there is no risk of electric shock, thereby eliminating safety hazards. Therefore, even if the output socket in the standby mode becomes submerged in or splashed with water, it will not become electrically connected to the neutral line and the live line of the outdoor power supply. Thus, if the user touches the surface of the socket under such conditions, no electric shock will occur, reducing the risk of electric shock after the socket is submerged in or splashed with water and eliminating safety hazards.

Second, the live terminal cavity 110 is in communication with the first drainage channel 150, the neutral terminal cavity 120 is in communication with a second drainage channel 160, and the earth terminal cavity 130 is in communication with a third drainage channel 170. The first drainage channel 150, the second drainage channel 160, and the third drainage channel 170 may quickly drain residual water from inside the output socket, reducing water accumulation within the output socket, thereby reducing a risk of a short circuit or conduction between the live line and the neutral line, and also reducing the risk of electric shock to the user.

The above are only preferred embodiments of the present disclosure. It should be noted that for those of ordinary skill in the art, several modifications and substitutions may be made without departing from the technical principles of the present disclosure. These modifications and substitutions should also be considered within the protection scope of the present disclosure.

1. An output socket, comprising: a socket body, a live terminal contact, a neutral terminal contact, and an earth terminal contact; wherein the socket body is provided therein with a live terminal cavity, a neutral terminal cavity, and an earth terminal cavity; the live terminal contact is disposed in the live terminal cavity, the neutral terminal contact is disposed in the neutral terminal cavity, and the earth terminal contact is disposed in the earth terminal cavity; the neutral terminal contact comprises a first elastic contact and a second elastic contact which are not electrically connected with each other, the first elastic contact is configured to connect to a neutral line, the second elastic contact is configured to connect to a detection signal line, and the first elastic contact and the second elastic contact is configured to clamp a neutral pin of a load plug through cooperation.

2. The output socket according to claim 1, wherein the live terminal cavity, the neutral terminal cavity, and the earth terminal cavity are not in communication with one another; the socket body is provided with a face panel; the face panel is provided with a live terminal insertion port, a neutral terminal insertion port, and an earth terminal insertion port; the live terminal insertion port is in communication with the live terminal cavity, the neutral terminal insertion port is in communication with the neutral terminal cavity, and the earth terminal insertion port is in communication with the earth terminal cavity.

3. The output socket according to claim 2, wherein the socket body is further provided with a first drainage channel, a second drainage channel, and a third drainage channel; the first drainage channel is in communication with an end of the live terminal cavity facing the live terminal insertion port; the second drainage channel is in communication with an end of the neutral terminal cavity facing the neutral terminal insertion port; and the third drainage channel is in communication with an end of the earth terminal cavity facing the earth terminal insertion port.

4. The output socket according to claim 3, wherein the socket body is provided with a partition cavity between the live terminal cavity and the neutral terminal cavity; the third drainage channel is located within the partition cavity; an outlet of the first drainage channel, an outlet of the second drainage channel, and an outlet of the third drainage channel are all located at a bottom of the face panel.

5. The output socket according to claim 4, wherein a first partition piece is provided between the outlet of the first drainage channel and the outlet of the third drainage channel; and a second partition piece is provided between the outlet of the second drainage channel and the outlet of the third drainage channel.

6. The output socket according to claim 2, wherein the face panel is further provided with a first isolation cavity and a second isolation cavity; the first isolation cavity is disposed between the live terminal insertion port and the live terminal contact; and the second isolation cavity is disposed between the neutral terminal insertion port and the neutral terminal contact.

7. The output socket according to claim 6, wherein a bottom of the face panel is provided with a first drainage port and a second drainage port; the first drainage port is in communication with the first isolation cavity, and the second drainage port is in communication with the second isolation cavity.

8. The output socket according to claim 2, wherein the face panel is provided with a water isolation groove at a location between the live terminal insertion port and the neutral terminal insertion port; an outlet of the water isolation groove extends to a bottom of the face panel.

9. The output socket according to claim 1, further comprising: a waterproof gasket and a rear pressure plate; wherein the waterproof gasket is located on a side of the rear pressure plate facing the socket body; the waterproof gasket and the rear pressure plate seal a rear opening of the live terminal cavity, a rear opening of the neutral terminal cavity, and a rear opening of the earth terminal cavity; and a side of the rear pressure plate facing away from the waterproof gasket is provided with a waterproof adhesive layer.

10. An outdoor power supply, comprising: the output socket according to claim 1 and a control component, wherein the control component is provided with a detection signal line, and the detection signal line is connected to the second elastic contact.

11. An outdoor power supply, comprising: the output socket according to claim 2 and a control component, wherein the control component is provided with a detection signal line, and the detection signal line is connected to the second elastic contact.

12. An outdoor power supply, comprising: the output socket according to claim 3 and a control component, wherein the control component is provided with a detection signal line, and the detection signal line is connected to the second elastic contact.

13. An outdoor power supply, comprising: the output socket according to claim 4 and a control component, wherein the control component is provided with a detection signal line, and the detection signal line is connected to the second elastic contact.

14. An outdoor power supply, comprising: the output socket according to claim 5 and a control component, wherein the control component is provided with a detection signal line, and the detection signal line is connected to the second elastic contact.

15. An outdoor power supply, comprising: the output socket according to claim 6 and a control component, wherein the control component is provided with a detection signal line, and the detection signal line is connected to the second elastic contact.

16. An outdoor power supply, comprising: the output socket according to claim 7 and a control component, wherein the control component is provided with a detection signal line, and the detection signal line is connected to the second elastic contact.

17. An outdoor power supply, comprising: the output socket according to claim 8 and a control component, wherein the control component is provided with a detection signal line, and the detection signal line is connected to the second elastic contact.

18. An outdoor power supply, comprising: the output socket according to claim 9 and a control component, wherein the control component is provided with a detection signal line, and the detection signal line is connected to the second elastic contact.
